(19) United States
(12) Patent Application Publication
(10) Pub. No.: US 2022/0213354 A1
(43) Pub. Date: Jul. 7, 2022

(54) Hot-Melt, Pressure-Sensitive Adhesive With A Wide Range Of Application-Temperature

(71) Applicant: Henry Company, LLC, El Segundo, CA (US)

(72) Inventors: Larisa Kasitskaya, Etobicoke (CA); Srdjan Stankovic, Toronto (CA); Thomas Tepe, King of Prussia, PA (US)

(21) Appl. No.: 17/402,885

(22) Filed: Aug. 16, 2021

Related U.S. Application Data
(60) Provisional application No. 63/065,668, filed on Aug. 14, 2020.

(51) Int. Cl. C09J 7/38; C09J 125/10; C09J 153/02; C09J 193/04

(52) U.S. Cl. CPC C09J 7/387; C09J 125/10; C09J 153/02; C09J 193/04; C09J 2203/346; C09J 2415/00; C09J 2301/122; C09J 2423/001; C09J 2453/00; C09J 2425/00; C09J 2301/302

(57) ABSTRACT

The present invention relates to hot-melt, pressure-sensitive adhesives (HM-PSA); self-adhering, vapor-permeable air-barriers comprising such HM-PSA; and the process of adhering such air-barriers on to construction material substrates in a primer-less fashion to control the vapor movement of water vapor and air.

### CROSS REFERENCE TO RELATED APPLICATIONS

This application claims the benefit of U.S. Provisional Application No. 63/065,668, filed Aug. 14, 2020, the entirety of which is incorporated herein for any and all purposes.

### FIELD OF THE INVENTION

The present invention relates to hot-melt, pressure-sensitive adhesives (HM-PSA); self-adhering, vapor-permeable air-barriers comprising such HM-PSA; and the process of adhering such air-barriers on to construction material substrates in a primer-less fashion to control the movement of water vapor and air.

### BACKGROUND

Modern building structures often use barrier-membrane sheet materials to simultaneously control the flow of moisture and the movement of air or ventilation in and out of the building's walls or the roof structure.

Typical membrane products are designed to be weather resistant, keeping out liquid water and resisting wind pressure. But at the same time, to alleviate problems of dampness or condensation within the building, wall, or roof structure, it is highly desirable that water vapor pass through relatively freely from the inside of the building to the outside, despite the membrane structure. Available water-vapor permeable membrane products combine weather resistance with water-vapor permeability. One type of product, incorporating macroporous film technology, has small pores which are amenable to diffusion of water molecules, driven by vapor pressure differential, from one side of the membrane sheet to the other—generally from inside the structure to out. Membranes which allow passage of water vapor but not that of air are generally referred to as vapor permeable air barriers. Self-adhered, vapor permeable air barriers employ a pressure sensitive adhesive that is coated on a water-vapor breathable fabric base. These air barrier membranes are adhered to the walls in order to control the flow of air but to allow transport of water vapor across the membrane.

Air-barrier, weather-resistant membrane sheets find use in a wide range of applications: for example, in forming a building envelope underneath the exterior cladding or the roofing material, which resists liquid water such as rain, but which allows escape of water vapor or trapped moisture from inside the structure.

Typical membrane sheeting is attached to a wall or roof structure, for example sheathing panels of a wall structure, by means of mechanical fasteners such screws or nails, or by adhesives such as a bitumen-based adhesive. Mechanical fasteners have known disadvantages, which make adhesive-based fastening or attachment a preferred option. Where a bitumen-based adhesive is employed, the area covered by the adhesive does not permit transmission of water vapor or air. It is important to note that a primer is often required to securely attach such adhesives to substrates.

U.S. Pat. No. 6,901,712 provides an air-barrier, water-vapor permeable membrane, which has a discontinuous adhesive layer attached to one surface. The discontinuous adhesive layer is used to stick the membrane to panels or sheathing substrates of a wall or roof structure without mechanical fixings. Self-adhesive membrane systems are commonly described as ‘peel-and-stick’ systems.

Generally, hot-melt based products recommend the use of primer for low temperature applications. On the other hand, while the acrylic-based PSA materials allow for a primer-less application of an air-barrier membrane onto a substrate, they are disadvantageously more expensive and are limited in their thickness in order to maintain a desired water vapor permeability.

What is more, the currently available PSAs and other adhesives demonstrate only a limited application-temperature range. Stated differently, adhesives that are functionally adequate at high temperatures may lose their adhesive ability or permeability at lower temperatures, and vice versa.

The hot-melt, pressure-sensitive adhesives of the present invention address the above problems.

### SUMMARY OF THE INVENTION

This invention provides a primer-less application of the air-barrier membrane onto a substrate; it has a wide application temperature range that a construction site is likely to undergo, from sub-zero to high temperatures in natural or artificial settings such as industrial. With primer-less application even at lower temperatures, these products provide labor savings, faster installation, and elimination of the primer cost. Also, the hot-melt, pressure-sensitive adhesives (HM-PSA) of the present invention can be applied in a discontinuous process or a continuous process to provide selected adjustment of water vapor permeability. The HM-PSA of the present invention are also lower cost than comparative acrylic technologies. In summary, this invention can help design a hot-melt adhesive that can be coated in discontinuous or a continuous fashion onto a breathable fabric, which then provides good adhesion down to lower service temperatures cited by acrylic products, but without compromising the current high service temperature performance.

In one embodiment, this invention relates to a hot-melt, pressure-sensitive adhesive (HM-PSA) composition, comprising a blend of the following components:

(A) at least one elastomeric copolymer selected from a styrene-isoprene elastomeric block copolymer (SIS); a styrene-butadiene elastomeric copolymer (SB); and a combination of SIS and SB;

(B) at least one tackifying compound selected from:
(I) at least one tackifying rosin ester having a softening point (SP) equal to or above the temperature selected from the range of from about 95° C. to about 125° C.,
(II) at least one tackifying rosin phenolics having a softening point equal to or above the temperature selected from the range of from about 95° C. to about 125° C., and
(III) at least one hydrogenated dicyclopentadiene resin having a softening point (SP) of at least about 125° C.; and

(C) a plasticizer;

wherein the glass transition temperature of the HM-PSA composition is equal to or below the temperature in the range of from about 0° C. to about −30° C.;

wherein the storage modulus (G′) at −18° C. is in the range of from about 300-2000 KPa; and

wherein the high T cross point of the HM-PSA composition is equal to or above the temperature in the range of from about 95° C. to about 125° C.

In another embodiment, this invention relates to a hot-melt, pressure-sensitive adhesive (HM-PSA) composition as described above, wherein said SB copolymer is selected from:
(i) a copolymer of SB;
(ii) a block copolymer of SB;
(iii) a radial, block copolymer of SB;
(iv) a linear, block copolymer of SB;
(v) a linear, random-block copolymer of SB; and
(vi) a blend or a combination of the above.

In yet another embodiment, this invention relates to a hot-melt, pressure-sensitive adhesive (HM-PSA) composition as described above, wherein the total content of said at least one elastomeric block copolymer, by percent weight of the HM-PSA composition is in the range of from about 20% to about 50%.

In one embodiment, this invention relates to a hot-melt, pressure-sensitive adhesive (HM-PSA) composition as described above, wherein:
(A) the SIS copolymer is a tri-block copolymer and is in the weight range of from 8% to about 30% by weight of the HM-PSA composition; and
(B) the SB copolymer is in the weight range of from about 8% to about 30% by weight of the HM-PSA composition.

In another embodiment, this invention relates to a hot-melt, pressure-sensitive adhesive (HM-PSA) composition as described above, wherein:
(C) said at least one tackifying rosin ester is in the weight range of from about 0% to about 40% by weight of the HM-PSA composition;
(D) said at least one tackifying rosin phenolics is in the weight range of from about 0% to about 40% by weight of the HM-PSA composition;
(E) said at least one hydrogenated dicyclopentadiene resin is in the weight range of from about 0% to about 40% by weight of the HM-PSA composition; and
(F) said plasticizer is in the weight range of from about 10% to about 30% by weight of the HM-PSA composition.

In yet another embodiment, this invention relates to a hot-melt, pressure-sensitive adhesive (HM-PSA) composition as described above, wherein:
(A) the SIS copolymer is in the weight range of from 11% to about 24% by weight of the HM-PSA composition;
(B) the SB copolymer is in the weight range of from about 11% to about 24% by weight of the HM-PSA composition;
(C) the at least one tackifying rosin ester is in the weight range of from about 10% to about 36% by weight of the HM-PSA composition; and/or
(D) the at least one tackifying rosin phenolics is in the weight range of from about 0% to about 33% by weight of the HM-PSA composition;
(E) the at least one hydrogenated dicyclopentadiene resin is in the weight range of from about 0% to about 20% by weight of the HM-PSA composition; and
(F) the plasticizer is in the weight range of from about 19% to about 24% by weight of the HM-PSA composition.

In one embodiment, this invention relates to a hot-melt, pressure-sensitive adhesive (HM-PSA) composition as described above, wherein:
(A) the SIS copolymer is in the weight range of from 21% to about 23% by weight of the HM-PSA composition;
(B) the SB copolymer is in the weight range of from about 21% to about 23% by weight of the HM-PSA composition;
(C) the at least one tackifying rosin ester is in the weight range of from about 13% to about 24% by weight of the HM-PSA composition;
(D) the at least one tackifying rosin phenolics is in the weight range of from about 0% to about 10% by weight of the HM-PSA composition; and
(E) the at least one hydrogenated dicyclopentadiene resin is in the weight range of from about 0% to about 20% by weight of the HM-PSA composition.

In another embodiment, this invention relates to a hot-melt, pressure-sensitive adhesive (HM-PSA) composition as described above, wherein the at least one tackifying rosin phenolics are characterized by a softening of at least about 120° C.

In yet another embodiment, this invention relates to a hot-melt, pressure-sensitive adhesive (HM-PSA) composition as described above, wherein the SIS copolymer has a styrene content of from about 10% to about 29%.

In one embodiment, this invention relates to a hot-melt, pressure-sensitive adhesive (HM-PSA) composition as described above, wherein the SIS copolymer is characterized by a linear tri-block structure.

In another embodiment, this invention relates to a hot-melt, pressure-sensitive adhesive (HM-PSA) composition as described above, wherein the SB copolymer has a styrene content of from about 10% to about 29%.

In yet another embodiment, this invention relates to a hot-melt, pressure-sensitive adhesive (HM-PSA) composition as described above, wherein the SB copolymer is characterized by a linear random structure.

In one embodiment, this invention relates to a hot-melt, pressure-sensitive adhesive (HM-PSA) composition as described above, wherein said melt-adhesive is characterized by an application temperature range of from about −25° C. to about 70° C.

In another embodiment, this invention relates to a hot-melt, pressure-sensitive adhesive (HM-PSA) composition as described above, wherein said melt-adhesive is characterized by a peel-adhesion strength that is at least 1 lbf/in the temperature range of −25° C. to 80° C.

In yet another embodiment, this invention relates to a hot-melt, pressure-sensitive adhesive (HM-PSA) composition as described above, wherein said melt-adhesive is characterized by a peel-adhesion strength that is at least 4 lbf/in the temperature range of −25° C. to 25° C. and at least 1 lbf/in at 80° C.

In one embodiment, this invention relates to a method for preparing an air-barrier membrane, comprising:
(a) providing a HM-PSA composition in a form adequate for application on a carrier; and
(b) applying said HM-PSA composition on said carrier in a discontinuous pattern, to form said air-barrier membrane;
wherein said HM-PSA composition comprises a blend of the following components:
   (A) at least one elastomeric block copolymer selected from a styrene-isoprene elastomeric block copolymer (SIS); a styrene-butadiene elastomeric block copolymer (SB); a combination of SIS and SB;
   (B) at least one tackifying compound selected from:
      (I) at least one tackifying rosin ester having a softening point (SP) equal to or above the temperature selected from the range of from about 95° C. to about 125° C.;
      (II) at least one tackifying rosin phenolics having a softening point equal to or above the temperature selected from the range of from about 95° C. to about 125° C.; and;
      (III) at least one hydrogenated dicyclopentadiene resin having a softening point (SP) of at least about 125° C.; and
   (C) a plasticizer;
wherein the glass transition temperature of the HM-PSA composition is equal to or below the temperature in the range of from about 0° C. to about −30° C.;
wherein the storage modulus (G′) at −18° C. is in the range of from about 300-2000 KPa; and
wherein the high T cross point of the HM-PSA composition is equal to or above the temperature in the range of from about 95° C. to about 125° C.

In another embodiment, this invention relates to an air-barrier membrane comprising a HM-PSA composition layer as recited previously, wherein said HM-PSA composition layer is applied in a discontinuous pattern. In yet another embodiment, this invention relates to such an air-barrier membrane, wherein said carrier is selected from polyolefin and polyester. In one embodiment, this invention further relates to such an air-barrier membrane, wherein said polyolefin is selected from polyethylene, polypropylene, a copolymer of polyethylene, a copolymer of polypropylene, a blend thereof, or a mixture thereof.

In another embodiment, this invention relates to a method for applying an air-barrier membrane onto a substrate, comprising:
(a) providing an air-barrier membrane as described in previously, that is adequate for application on a carrier; and
(b) applying said air-barrier membrane without a primer on said substrate to form a covered substrate;
wherein said HM-PSA composition comprises a blend of the following components:
   (A) at least one elastomeric block copolymer selected from a styrene-isoprene elastomeric block copolymer (SIS); a styrene-butadiene elastomeric block copolymer (SB); a combination of SIS and SB;
   (B) at least one tackifying compound selected from:
      (I) at least one tackifying rosin ester having a softening point (SP) equal to or above the temperature selected from the range of from about 95° C. to about 125° C.;
      (II) at least one tackifying rosin phenolics having a softening point equal to or above the temperature selected from the range of from about 95° C. to about 125° C.; and;
      (III) at least one hydrogenated dicyclopentadiene resin having a softening point (SP) of at least about 125° C.; and
   (C) a plasticizer;
wherein the glass transition temperature of the HM-PSA composition is equal to or below the temperature in the range of from about 0° C. to about −30° C.;
wherein the storage modulus (G′) at −18° C. is in the range of from about 300-2000 KPa; and
wherein the high T cross point of the HM-PSA composition is equal to or above the temperature in the range of from about 95° C. to about 125° C.

In yet another embodiment, this invention relates to a covered substrate prepared by the method described above. In a further embodiment, this invention relates to such a covered substrate described above, wherein said substrate is selected from gypsum board, plywood, laminated veneer lumber (LVL), particle board, fiberboard, wafer board, glue-lam beams, structural composite lumber, oriented strand board (OSB), oriented strand lumber (OSL) or parallel strand lumber (PSL), concrete masonry unit (CMU), concrete, and masonry.

In one embodiment, this invention relates to method for preparing an air-barrier membrane, comprising:
(a) providing a HM-PSA composition in a form adequate for application on a carrier; and
(b) applying said HM-PSA composition on said carrier in a continuous pattern, to form said air-barrier membrane;
wherein said HM-PSA composition comprises a blend of the following components:
   (A) at least one elastomeric block copolymer selected from a styrene-isoprene elastomeric block copolymer (SIS); a styrene-butadiene elastomeric block copolymer (SB); a combination of SIS and SB;
   (B) at least one tackifying compound selected from:
      (I) at least one tackifying rosin ester having a softening point (SP) equal to or above the temperature selected from the range of from about 95° C. to about 125° C.;
      (II) at least one tackifying rosin phenolics having a softening point equal to or above the temperature selected from the range of from about 95° C. to about 125° C.; and;
      (III) at least one hydrogenated dicyclopentadiene resin having a softening point (SP) of at least about 125° C.; and
   (C) a plasticizer;
wherein the glass transition temperature of the HM-PSA composition is equal to or below the temperature in the range of from about 0° C. to about −30° C.;
wherein the storage modulus (G′) at −18° C. is in the range of from about 300-2000 KPa; and
wherein the high T cross point of the HM-PSA composition is equal to or above the temperature in the range of from about 95° C. to about 125° C.

This invention also relates to an air-barrier membrane comprising a HM-PSA composition layer as recited above, wherein said HM-PSA composition layer is applied in a continuous pattern. This invention also relates to such an air-barrier membrane, wherein said carrier is selected from polyolefin and polyester. This invention further relates to such an air-barrier membrane, wherein said polyolefin is selected from polyethylene, polypropylene, a copolymer of polyethylene, a copolymer of polypropylene, a blend thereof, or a mixture thereof.

This invention relates to a method for applying an air-barrier membrane onto a substrate, comprising:
(a) providing an air-barrier membrane as described above for the continuous pattern application of the HM-PSA, that is adequate for application on a carrier; and
(b) applying said air-barrier membrane without a primer on said substrate to form a covered substrate;
wherein said HM-PSA composition comprises a blend of the following components:
   (A) at least one elastomeric block copolymer selected from a styrene-isoprene elastomeric block copolymer (SIS); a styrene-butadiene elastomeric block copolymer (SB); a combination of SIS and SB;
   (B) at least one tackifying compound selected from:
      (I) at least one tackifying rosin ester having a softening point (SP) equal to or above the temperature selected from the range of from about 95° C. to about 125° C.;
      (II) at least one tackifying rosin phenolics having a softening point equal to or above the temperature selected from the range of from about 95° C. to about 125° C.; and;
      (III) at least one hydrogenated dicyclopentadiene resin having a softening point (SP) of at least about 125° C.; and
   (C) a plasticizer;
wherein the glass transition temperature of the HM-PSA composition is equal to or below the temperature in the range of from about 0° C. to about −30° C.;
wherein the storage modulus (G′) at −18° C. is in the range of from about 300-2000 KPa; and
wherein the high T cross point of the HM-PSA composition is equal to or above the temperature in the range of from about 95° C. to about 125° C.

This invention also relates to a covered substrate prepared by the method described above, wherein the HM-PSA is applied in a continuous fashion. This invention further relates to such a covered substrate, wherein said substrate is selected from gypsum board, plywood, laminated veneer lumber (LVL), particle board, fiberboard, wafer board, glue-lam beams, structural composite lumber, oriented strand board (OSB), oriented strand lumber (OSL) or parallel strand lumber (PSL), concrete masonry unit (CMU), concrete, and masonry.

### BRIEF DESCRIPTION OF DRAWINGS

FIG. 1 relates to the Dynamic Mechanical Analysis of various experimental compositions of the invention.

### DESCRIPTION OF THE INVENTION

### I. General Invention

In one aspect, the present invention relates to hot-melt, pressure-sensitive adhesives (HM-PSA). In another aspect, this invention relates to process of preparing these HM-PSA.

In yet another aspect, this invention relates to an air-barrier membrane comprising a carrier on which the hot-melt, pressure-sensitive adhesive is applied. In another aspect, this invention relates to the process of preparing such air-barrier membranes comprising the carrier and the HM-PSA. In another aspect, this invention relates to a method of applying the HM-PSA on the carrier, forming a discontinuous pattern. In yet another aspect, this invention relates to a method of applying the HM-PSA on the carrier, forming a continuous pattern or layer.

In a further aspect, this invention relates to a substrate comprising the aforementioned air-barrier membrane. In another aspect, this invention relates to a method of applying or adhering such air-barrier membrane on the substrate.

### II. Hot-Melt, Pressure-Sensitive Adhesive

### A. Discontinuous Application

In one aspect, the present invention relates to a hot-melt, pressure-sensitive adhesive (HM-PSA), and more particularly to a block copolymer-based HM-PSA. These block copolymers have a viscoelastic profile that allows the design of any type of a carrier on which the HM-PSA can be applied in a discontinuous manner. The resulting permeable material of the present invention, for example, an air-barrier membrane, has a wide application temperature range from −25° C. to 70° C., and which forms a strong bond to itself (cohesive) and to the substrate (adhesive) without the use of a primer. The primer-less applicability of the carrier to the substrate with a low-temperature utility and a high-temperature continuous service amenability is the special feature of the hot-melt, pressure-sensitive adhesives of the present invention.

In one embodiment, this invention relates to a hot-melt, pressure-sensitive adhesive (HM-PSA) composition comprising a blend of: at least one block copolymer, at least one tackifying resin, and at least one plasticizer; wherein the HM-PSA exhibits the viscoelastic profile that allows for a wide application-temperature range.

In one embodiment, the glass transition temperature of the hot-melt, pressure-sensitive adhesive (HM-PSA) is less than or equal to the number listed herein, in ° C.: 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, and −30. The Tg can also be less than or equal to a number that is within the range defined by any two numbers herein, including the endpoints of such range.

In one embodiment, the storage modulus (G′) of the HM-PSA, as measure at −18° C. is in the range of from about 300 KPa to about 2,000 KPa. Stated another way, the storage modulus (G′) of the HM-PSA is any number from the listing of numbers herein, in KPa: 300, 400, 500, 600, 700, 800, 900, 1000, 1100, 1200, 1300, 1400, 1500, 1600, 1700, 1800, 1900, and 2000. The storage modulus can also be a number that is within the range defined by any two numbers herein, including the endpoints of such range.

In one embodiment, the high T cross point of the HM-PSA composition is equal to or more than the number listed herein, in ° C.: 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, and 125. The high T cross point can also be a number that is within the range defined by any two numbers herein, including the endpoints of such range.

In one embodiment, the high T cross point of the HM-PSA composition is equal to or more than the number listed herein, in ° C.: 98, 99, 100, 101, 102, 103, 104, 105, 106, 107, 108, 109, 110, 111, 112, 113, 114, and 115. The high T cross point can also be a number that is within the range defined by any two numbers herein, including the endpoints of such range.

In one embodiment, the high T cross point of the HM-PSA composition is equal to or more than the number listed herein, in ° C.: 100, 101, 102, 103, 104, 105, 106, 107, 108, 109, and 110. The high T cross point can also be a number that is within the range defined by any two numbers herein, including the endpoints of such range.

### B. Continuous Application

In one aspect, the present invention relates to a hot-melt pressure-sensitive adhesive (HM-PSA), and more particularly to a block copolymer-based HM-PSA having a viscoelastic profile that allows the design of any type of a carrier on which the HM-PSA can be applied in a continuous manner. The resulting impermeable material of the present invention, for example, an air-barrier membrane, has a wide application temperature range from −25° C. to 70° C., and which forms a strong bond to itself (cohesive) and to the substrate (adhesive) without the use of a primer. The primer-less applicability of the carrier to the substrate with a low-temperature utility and a high-temperature continuous service amenability is the special feature of the hot-melt, pressure-sensitive adhesives of the present invention.

In one embodiment, this invention relates to a hot-melt, pressure-sensitive adhesive (HM-PSA) composition comprising a blend of: at least one block copolymer, at least one tackifying resin, and at least one plasticizer; wherein the HM-PSA exhibits the viscoelastic profile that allows for a wide application-temperature range.

In one embodiment, the glass transition temperature of the hot-melt, pressure-sensitive adhesive (HM-PSA) is less than or equal to the number listed herein, in ° C.: 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, and −30. The Tg can also be less than or equal to a number that is within the range defined by any two numbers herein, including the endpoints of such range.

In one embodiment, the storage modulus (G′) of the HM-PSA, as measure at −18° C. is in the range of from about 300 KPa to about 2,000 KPa. Stated another way, the storage modulus (G′) of the HM-PSA is any number from the listing of numbers herein, in KPa: 300, 400, 500, 600, 700, 800, 900, 1000, 1100, 1200, 1300, 1400, 1500, 1600, 1700, 1800, 1900, and 2000. The storage modulus can also be a number that is within the range defined by any two numbers herein, including the endpoints of such range.

In one embodiment, the high T cross point of the HM-PSA composition is equal to or more than the number listed herein, in ° C.: 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, and 125. The high T cross point can also be a number that is within the range defined by any two numbers herein, including the endpoints of such range.

In one embodiment, the high T cross point of the HM-PSA composition is equal to or more than the number listed herein, in ° C.: 98, 99, 100, 101, 102, 103, 104, 105, 106, 107, 108, 109, 110, 111, 112, 113, 114, and 115. The high T cross point can also be a number that is within the range defined by any two numbers herein, including the endpoints of such range.

In one embodiment, the high T cross point of the HM-PSA composition is equal to or more than the number listed herein, in ° C.: 100, 101, 102, 103, 104, 105, 106, 107, 108, 109, and 110. The high T cross point can also be a number that is within the range defined by any two numbers herein, including the endpoints of such range.

### C. Elastomeric Copolymers

In one embodiment of the invention of the hot-melt, pressure-sensitive adhesive described supra, the elastomeric copolymer is a styrene-isoprene-styrene elastomeric block copolymer (SIS).

In one embodiment of the invention, the elastomeric copolymer is a copolymer of SB.

In one embodiment of the invention, the elastomeric copolymer is a block copolymer of SB.

In one embodiment of the invention, the elastomeric copolymer is a radial block copolymer of SB.

In one embodiment of the invention, the elastomeric copolymer is a linear, block copolymer of SB.

In one embodiment of the invention, the elastomeric copolymer is a linear, random-block copolymer of SB.

In another embodiment of the invention, the elastomeric copolymer is blend or a combination of two or more of:
(i) a copolymer of SB;
(ii) a block copolymer of SB;
(iii) a radial, block copolymer of SB;
(iv) a linear, block copolymer of SB;
(v) a linear, random-block copolymer of SB; and
(vi) a styrene-isoprene-styrene elastomeric block copolymer (SIS).

In one embodiment, the hot-melt, pressure-sensitive adhesive (HM-PSA) composition comprises the elastomeric copolymers described supra.

In one embodiment, the total elastomeric copolymer content, by percent weight of the HM-PSA composition is in the range of from about 20% to about 70%. Stated another way, the total elastomeric copolymer content by percent weight of the HM-PSA composition is any one of the numbers from the following list of numbers: 20%, 21%, 22%, 23%, . . . , 67%, 68%, 69%, and 70%. The total elastomeric copolymer content by percent weight of the HM-PSA composition can also be within a range defined by any two numbers listed herein, including the endpoints of such range.

In one embodiment, the total elastomeric copolymer content, by percent weight of the HM-PSA composition is in the range of from about 20% to about 50%. Stated another way, the total elastomeric copolymer content by percent weight of the HM-PSA composition is any one of the numbers from the following list of numbers: 20%, 21%, 22%, 23%, . . . , 47%, 48%, 49%, and 50%. The total elastomeric copolymer content by percent weight of the HM-PSA composition can also be within a range defined by any two numbers listed herein, including the endpoints of such range.

In one embodiment, the total elastomeric copolymer content, by percent weight of the HM-PSA composition is in the range of from about 40% to about 50%. Stated another way, the total elastomeric copolymer content by percent weight of the HM-PSA composition is any one of the numbers from the following list of numbers: 40%, 41%, 42%, 43%, 44%, 45%, 46%, 47%, 48%, 49%, and 50%. The total elastomeric copolymer content by percent weight of the HM-PSA composition can also be within a range defined by any two numbers listed herein, including the endpoints of such range.

In one embodiment, the SIS block copolymer content in the total elastomeric copolymer content is from 0% to 100%, and correspondingly, the SB copolymer content in the total elastomeric copolymer content is from 100% to 0% to make the total elastomeric block copolymer content at 100%. Stated another way, the SIS block copolymer content in the total elastomeric copolymer content is any one of the numbers from the following list of numbers: 0%, 1%, 2%, 3%, . . . , 97%, 98%, 99%, and 100%. The SIS block copolymer content in the total elastomeric copolymer content can also be within a range defined by any two numbers listed herein, including the endpoints of such range. Similarly, in the same embodiment, the corresponding SB copolymer content in the total elastomeric copolymer content is any one of the numbers from the following list of numbers: 100%, 99%, 98%, 97%, . . . , 3%, 2%, 1%, 0%. The SB copolymer content in the total elastomeric copolymer content can also be within a range defined by any two numbers listed herein, including the endpoints of such range.

In one embodiment of the invention, the SIS block copolymer content in the total elastomeric copolymer content is in the range of 40-60% and correspondingly, the SB copolymer content in the total elastomeric copolymer content is in the range of 60-40%. Stated differently, the SIS block copolymer content in the total elastomeric copolymer content is any one of the numbers from the following list of numbers: 40%, 41%, 42%, 43%, 44%, 45%, 46%, 47%, 48%, 49%, 50%, 51%, 52%, 53%, 54%, 55%, 56%, 57%, 58%, 59%, and 60%. The SIS block copolymer content in the total elastomeric copolymer content can also be within a range defined by any two numbers listed herein, including the endpoints of such range. Similarly, in the same embodiment, the corresponding SB copolymer content in the total elastomeric copolymer content is any one of the numbers from the following list of numbers: 60%, 59%, 58%, 57%, 56%, 55%, 54%, 53%, 52%, 51%, 50%, 49%, 48%, 47%, 46%, 45%, 44%, 43%, 42%, 41%, and 40%. The SB copolymer content in the total elastomeric copolymer content can also be within a range defined by any two numbers listed herein, including the endpoints of such range.

In one embodiment of the invention, the SIS block copolymer content in the total elastomeric copolymer content is in the range of 45-55% and correspondingly, the SB copolymer content in the total elastomeric copolymer content is in the range of 55-45%. Stated differently, the SIS block copolymer content in the total elastomeric block copolymer content is any one of the numbers from the following list of numbers: 45%, 46%, 47%, 48%, 49%, 50%, 51%, 52%, 53%, 54%, and 55%. The SIS block copolymer content in the total elastomeric copolymer content can also be within a range defined by any two numbers listed herein, including the endpoints of such range. Similarly, in the same embodiment, the corresponding SB copolymer content in the total elastomeric copolymer content is any one of the numbers from the following list of numbers: 55%, 54%, 53%, 52%, 51%, 50%, 49%, 48%, 47%, 46%, and 45%. The SB copolymer content in the total elastomeric copolymer content can also be within a range defined by any two numbers listed herein, including the endpoints of such range.

a. Styrene-Isoprene-Styrene (SIS) Block Copolymer

In one embodiment of the invention, the SIS block copolymer is characterized by (i, (ii) a tri-block structure, or (iii) a blend or mixture of the di-block structure and the tri-block structure. In another embodiment of the invention, the SIS block copolymer is characterized by a linear structure. In one embodiment, the SIS block copolymer molecular weight range varies from about 40,000 g/mol to 500,000 g/mol.

The SIS block copolymers useful in the hot-melt, pressure-sensitive adhesive (HM-PSA) of the present disclosure include a blend of A-B-A tri-block and A-B di-block copolymers. More specifically, the styrene-isoprene-containing block copolymers useful in the HM-PSA of the present disclosure include a styrene-isoprene (SI) di-block copolymer and a styrene-isoprene-styrene (SIS) tri-block copolymer. Such SIS tri-blocks include styrene end-blocks and isoprene mid-blocks (SIS).

In certain embodiments of a styrene-isoprene-styrene block copolymer, the total amount of styrene-isoprene di-block copolymer is present in an amount in range of from about 15% to about 85% by weight of the total styrene-isoprene-styrene block copolymer, which is a sum total of the SI di-block and the SIS tri-block copolymers. Stated another way, the di-block copolymer content in the SIS block copolymer is defined by any one of the following numbers: 15%, 16%, 17%, . . . , 83%, 84%, and 85%. The di-block copolymer content in the SIS block copolymer can also be within a range defined by any two numbers listed herein, including the endpoints of such range.

In one embodiment of the invention, the styrene content, by weight, in the SIS block copolymer is in the range of from about 10% to about 29%. Stated differently, the styrene content in the SIS block copolymer is any one of the numbers from the following list of numbers: 10%, 11%, 12%, 13%, 14%, 15%, 16%, 17%, 18%, 19%, 20%, 21%, 22%, 23%, 24%, 25%, 26%, 27%, 28%, and 29%. The styrene content in the SIS block copolymer can also be within a range defined by any two numbers listed herein, including the endpoints of such range.

In one embodiment of the invention, the styrene content, by weight, in the SIS block copolymer is in the range of from about 14% to about 29%. Stated differently, the styrene content in the SIS block copolymer is any one of the numbers from the following list of numbers: 14%, 15%, 16%, 17%, 18%, 19%, 20%, 21%, 22%, 23%, 24%, 25%, 26%, 27%, 28%, and 29%. The styrene content in the SIS block copolymer can also be within a range defined by any two numbers listed herein, including the endpoints of such range.

In one embodiment of the invention, the styrene content, by weight, in the SIS block copolymer is in the range of from about 20% to about 24%. Stated differently, the styrene content in the SIS block copolymer is any one of the numbers from the following list of numbers: 20%, 21%, 22%, 23%, and 24%. The styrene content in the SIS block copolymer can also be within a range defined by any two numbers listed herein, including the endpoints of such range.

In certain embodiments, the SIS block copolymers have a linear or radial configuration. In certain embodiments, the SIS block copolymers have a linear configuration. In certain embodiments of the SIS tri-blocks, the styrene end-blocks have molecular weights ranging from 5,000 g/mol to 100,000 g/mol. Stated differently, the styrene end-blocks have molecular weights is any one of the numbers from the following list of numbers in g/mol: 5,000; 6,000; 7,000 ; ; ; 98,000; 99,000; and 100,000. The styrene end-blocks molecular weight in the SIS block copolymer can also be within a range defined by any two numbers listed herein, including the endpoints of such range.

In certain embodiments of the SIS tri-blocks, the styrene end-blocks have molecular weights ranging from 10,000 g/mol to 80,000 g/mol. Stated differently, the styrene end-blocks have molecular weights is any one of the numbers from the following list of numbers in g/mol: 10,000; 11,000; 12,000 ; ; ; 78,000; 79,000; and 80,000. The styrene end-blocks molecular weight in the SIS block copolymer can also be within a range defined by any two numbers listed herein, including the endpoints of such range.

In certain embodiments of the SIS tri-blocks, the styrene end-blocks have molecular weights ranging from 20,000 g/mol to 65,000 g/mol. Stated differently, the styrene end-blocks have molecular weights is any one of the numbers from the following list of numbers in g/mol: 20,000; 21,000; 22,000; . . . 63,000; 64,000; and 65,000. The styrene end-blocks molecular weight in the SIS block copolymer can also be within a range defined by any two numbers listed herein, including the endpoints of such range.

In certain embodiments of the SIS tri-blocks, the isoprene mid-blocks have molecular weights ranging from 25,000 g/mol to 300,000 g/mol. Stated differently, the isoprene mid-blocks have molecular weights is any one of the numbers from the following list of numbers in g/mol: 25,000; 35000; 40,000 ; ; ; 290,000; 295,000; and 300,000. The isoprene mid-blocks molecular weight in the SIS block copolymer can also be within a range defined by any two numbers listed herein, including the endpoints of such range.

In certain embodiments of the SIS tri-blocks, the isoprene mid-blocks have molecular weights ranging from 75,000 g/mol to 250,000 g/mol. Stated differently, the isoprene mid-blocks have molecular weights is any one of the numbers from the following list of numbers in g/mol: 75,000; 85,000; 95,000 ; ; ; 2300,000; 240,000; and 250,000. The isoprene mid-blocks molecular weight in the SIS block copolymer can also be within a range defined by any two numbers listed herein, including the endpoints of such range.

In certain embodiments of the SIS tri-blocks, the isoprene mid-blocks have molecular weights ranging from 125,000 g/mol to 200,000 g/mol. Stated differently, the isoprene mid-blocks have molecular weights is any one of the numbers from the following list of numbers in g/mol: 125,000; 135,000; 145,000; 155,000; 165,000; and 175,000; 185,000; 195,000; and 200,000. The isoprene mid-blocks molecular weight in the SIS block copolymer can also be within a range defined by any two numbers listed herein, including the endpoints of such range.

In one embodiment, more than one type of SIS block copolymer may be present in the HM-PSA. The varying types of SIS block copolymer include varying grades of SIS, such as by molecular weight, styrenic content, randomness of structure, and linearity or the non-linearity of the blocks. For example, in one HM-PSA, SIS block copolymers may be present which differ in molecular weight. Clearly, the two grades of SIS block copolymers upon blending would manifest as one SIS block copolymer with an average molecular weight of the two grades. Similar variation in the styrene content of the SIS block copolymer, for example, between two grades, is within the ambit of the present invention.

b. Styrene-Butadiene Copolymers

In one embodiment of the invention of the hot-melt, pressure-sensitive adhesive (HM-PSA), the styrene-butadiene copolymer is one of the following:
(i) a copolymer of SB;
(ii) a block copolymer of SB;
(iii) a radial, block copolymer of SB;
(iv) a linear, block copolymer of SB;
(v) a linear, random-block copolymer of SB; and
(vi) a blend or a combination of the above.

In the AB di-block and linear random-block copolymer structures, and (A-B)n radial block copolymer structures, the A blocks are non-elastomeric polymer blocks comprising polystyrene and the B blocks are mainly unsaturated conjugated butadiene or its partly hydrogenated version. The B block is butadiene or ethylene-butylene (hydrogenated butadiene), and mixtures thereof.

In one embodiment of the invention, the styrene content, by weight, in the SB copolymer is in the range of from about 10% to about 29%. Stated differently, the styrene content in the SB copolymer is any one of the numbers from the following list of numbers: 10%, 11%, 12%, 13%, 14%, 15%, 16%, 17%, 18%, 19%, 20%, 21%, 22%, 23%, 24%, 25%, 26%, 27%, 28%, and 29%. The styrene content in the SB copolymer can also be within a range defined by any two numbers listed herein, including the endpoints of such range.

In one embodiment of the invention, the styrene content, by weight, in the SB copolymer is in the range of from about 14% to about 29%. Stated differently, the styrene content in the SB copolymer is any one of the numbers from the following list of numbers: 14%, 15%, 16%, 17%, 18%, 19%, 20%, 21%, 22%, 23%, 24%, 25%, 26%, 27%, 28%, and 29%. The styrene content in the SB copolymer can also be within a range defined by any two numbers listed herein, including the endpoints of such range.

In one embodiment of the invention, the styrene content, by weight, in the SB copolymer is in the range of from about 23% to about 27%. Stated differently, the styrene content in the SB copolymer is any one of the numbers from the following list of numbers: 23%, 24%, 25%, 26%, and 27%. The styrene content in the SB copolymer can also be within a range defined by any two numbers listed herein, including the endpoints of such range.

In one embodiment of the invention, the SB block copolymer is characterized by a linear random structure. In one embodiment, the SB copolymer molecular weight range varies from about 40,000 to 300,000 g/mol.

In certain embodiments of the SB copolymer, the styrene has molecular weights ranging from 5,000 g/mol to 130,000 g/mol. Stated differently, the styrene molecular weight is any one of the numbers from the following list of numbers in g/mol: 5,000; 6,000; 7,000 ; ; ; 128,000; 129,000; and 130,000. The styrene molecular weight in the SB copolymer can also be within a range defined by any two numbers listed herein, including the endpoints of such range.

In certain embodiments of the SB di-blocks, the styrene blocks have molecular weights ranging from 10,000 g/mol to 90,000 g/mol. Stated differently, the styrene block molecular weight is any one of the numbers from the following list of numbers in g/mol: 10,000; 11,000; 12,000 ; ; ; 88,000; 89,000; and 90,000. The styrene blocks molecular weight in the SB block copolymer can also be within a range defined by any two numbers listed herein, including the endpoints of such range.

In certain embodiments of the SB di-blocks, the styrene blocks have molecular weights ranging from 15,000 g/mol to 65,000 g/mol. Stated differently, the styrene block molecular weight is any one of the numbers from the following list of numbers in g/mol: 15,000; 16,000; 17,000; . . . ; 63,000; 64,000; and 65,000. The styrene blocks molecular weight in the SB block copolymer can also be within a range defined by any two numbers listed herein, including the endpoints of such range.

In certain embodiments of the SB di-blocks, the butadiene blocks have molecular weights ranging from 25,000 g/mol to 250,000 g/mol. Stated differently, the butadiene block molecular weight is any one of the numbers from the following list of numbers in g/mol: 25,000; 35000; 40,000 ; ; ; 240,000; 245,000; and 250,000. The butadiene blocks molecular weight in the SB block copolymer can also be within a range defined by any two numbers listed herein, including the endpoints of such range.

In certain embodiments of the SB di-blocks, the butadiene blocks have molecular weights ranging from 35,000 g/mol to 200,000 g/mol. Stated differently, the butadiene block molecular weight is any one of the numbers from the following list of numbers in g/mol: 35,000; 45,000; 55,000 ; ; ; 185,000; 195,000; and 200,000. The butadiene blocks molecular weight in the SB block copolymer can also be within a range defined by any two numbers listed herein, including the endpoints of such range.

In certain embodiments of the SB di-blocks, the butadiene blocks have molecular weights ranging from 70,000 g/mol to 175,000 g/mol. Stated differently, the butadiene block molecular weight is any one of the numbers from the following list of numbers in g/mol: 70,000; 80,000; 90,000; . . . ; 160,000; 170,000; and 175,000. The butadiene blocks molecular weight in the SB block copolymer can also be within a range defined by any two numbers listed herein, including the endpoints of such range.

In one embodiment, more than one type of SB block copolymer may be present in the HM-PSA. The varying types of SB block copolymer include varying grades of SB, such as by molecular weight, styrenic content, randomness of structure, and linearity or the non-linearity of the blocks. For example, in one HM-PSA, SB block copolymers may be present, which differ in molecular weight. Clearly, the two grades of SB block copolymers upon blending would manifest as one SB block copolymer with an average molecular weight of the two grades. Similar variation in the styrene content of the SB block copolymer, for example, between two grades, is within the ambit of the present invention.

In one embodiment, the styrene-butadiene random copolymer contains about 15 to about 35 weight percent styrene. In another embodiment, styrene-butadiene diblock copolymers containing about 15 to about 40 weight percent styrene. In another embodiment, the styrene-butadiene multiblock copolymers contains about 35 to about 55 weight percent styrene.

In one embodiment, the hot-melt, pressure-sensitive adhesive of the present invention contains at least one styrene-butadiene block copolymer with a linear tri-block structure, and a styrene content of 20 to 35 weight percent. Such block copolymers generally will be present in amounts of from about 5 to about 25 percent or, in some embodiments, from about 7 to about 20 percent of the total weight of the adhesive.

### B. Tackifying Compounds

As stated supra, apart from the elastomeric block copolymers, the hot-melt, pressure-sensitive adhesive (HM-PSA) composition also includes at least one tackifying compound. The tackifying compounds increase the tack of the HM-PSA. Suitable tackifiers may associate with the mid-block phase or with the end-block phase of the elastomeric copolymers. In one embodiment, the mid-block is an isoprene rich phase and the end-block is a styrene-rich phase in an SIS block copolymer. The tackifying compounds include at least one tackifying rosin ester; at least one tackifying rosin phenolics; and at least one hydrogenated dicyclopentadiene resin.

a. Rosin Ester

In one embodiment, in the hot-melt, pressure-sensitive adhesive (HM-PSA), the tackifying rosin ester is in the range of 0 to 40% by weight of the hot-melt, pressure-sensitive adhesive. Stated differently, the tackifying rosin ester is any one of the numbers from the following list of numbers in percent weight of the HM-PSA: 0%, 1%, 2%, . . . , 38%, 39%, and 40%. The tackifying rosin ester in the HM-PSA can also be within a range defined by any two numbers listed herein, including the endpoints of such range.

In one embodiment, in the HM-PSA, the tackifying rosin ester is in the range of 10 to 36% by weight of the hot-melt, pressure-sensitive adhesive. Stated differently, the tackifying rosin ester is any one of the numbers from the following list of numbers in percent weight of the HM-PSA: 10%, 11%, 12%, . . . , 34%, 35%, and 36%. The tackifying rosin ester in the HM-PSA can also be within a range defined by any two numbers listed herein, including the endpoints of such range.

In one embodiment, in the HM-PSA, the tackifying rosin ester is in the range of 13 to 24% by weight of the hot-melt, pressure-sensitive adhesive. Stated differently, the tackifying rosin ester is any one of the numbers from the following list of numbers in percent weight of the HM-PSA: 13%, 14%, 15%, 16%, 17%, 18%, 19%, 20%, 21%, 22%, 23%, and 24%. The tackifying rosin phenolics in the HM-PSA can also be within a range defined by any two numbers listed herein, including the endpoints of such range.

In one embodiment, the softening point of the tackifying rosin ester in the HM-PSA composition is equal to or more than the number listed herein, in ° C.: 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, and 125. The softening point can also be a number that is within the range defined by any two numbers herein, including the endpoints of such range.

In one embodiment, the softening point of the tackifying rosin ester in the HM-PSA composition is equal to or more than the number listed herein, in ° C.: 98, 99, 100, 101, 102, 103, 104, 105, 106, 107, 108, 109, 110, 111, 112, 113, 114, and 115. The softening point can also be a number that is within the range defined by any two numbers herein, including the endpoints of such range.

In one embodiment, the softening point of the tackifying rosin ester in the HM-PSA composition is equal to or more than the number listed herein, in ° C.: 100, 101, 102, 103, 104, 105, 106, 107, 108, 109, and 110. The softening point can also be a number that is within the range defined by any two numbers herein, including the endpoints of such range.

In one embodiment of the HM-PSA, more than one tackifying rosin ester can be used.

b. Rosin Phenolics

In one embodiment, in the hot-melt, pressure-sensitive adhesive (HM-PSA), the tackifying compound is the rosin phenolics, which is in the range of 0 to 40% by weight of the hot-melt, pressure-sensitive adhesive. Stated differently, the tackifying rosin phenolics is any one of the numbers from the following list of numbers in percent weight of the HM-PSA: 0%, 1%, 2%, . . . , 38%, 39%, and 40%. The tackifying rosin phenolics in the HM-PSA can also be within a range defined by any two numbers listed herein, including the endpoints of such range.

In one embodiment, in the HM-PSA, the tackifying compound is the rosin phenolics, which is in the range of 0 to 33% by weight of the hot-melt, pressure-sensitive adhesive. Stated differently, the tackifying rosin phenolics is any one of the numbers from the following list of numbers in percent weight of the HM-PSA: 0%, 1%, 2%, . . . , 31%, 32%, and 33%. The tackifying rosin phenolics in the HM-PSA can also be within a range defined by any two numbers listed herein, including the endpoints of such range.

In one embodiment, in the HM-PSA, the tackifying compound is the rosin phenolics, which is in the range of 0 to 10% by weight of the hot-melt, pressure-sensitive adhesive. Stated differently, the tackifying rosin phenolics is any one of the numbers from the following list of numbers in percent weight of the HM-PSA: 0%, 1%, 2%, 3%, 4%, 5%, 6%, 7%, 8%, 9%, and 10%. The tackifying rosin phenolics in the HM-PSA can also be within a range defined by any two numbers listed herein, including the endpoints of such range.

In one embodiment, the softening point of the tackifying rosin phenolics in the HM-PSA composition is equal to or more than the number listed herein, in ° C.: 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, and 125. The softening point can also be a number that is within the range defined by any two numbers herein, including the endpoints of such range.

In one embodiment, the softening point of the tackifying rosin phenolics in the HM-PSA composition is equal to or more than the number listed herein, in ° C.: 98, 99, 100, 101, 102, 103, 104, 105, 106, 107, 108, 109, 110, 111, 112, 113, 114, and 115. The softening point can also be a number that is within the range defined by any two numbers herein, including the endpoints of such range.

In one embodiment, softening point of the tackifying rosin phenolics in the HM-PSA composition is equal to or more than the number listed herein, in ° C.: 100, 101, 102, 103, 104, 105, 106, 107, 108, 109, and 110. The softening point can also be a number that is within the range defined by any two numbers herein, including the endpoints of such range.

In one embodiment of the HM-PSA, more than one tackifying rosin phenolics can be used.

c. Hydrogenated Dicyclopentadiene Resin

In one embodiment, in the HM-PSA, the tackifying compound is hydrogenated dicyclopentadiene resin, which is in the range of 0 to 40% by weight of the hot-melt, pressure-sensitive adhesive (HM-PSA). Stated differently, the tackifying hydrogenated dicyclopentadiene is any one of the numbers from the following list of numbers in percent weight of the HM-PSA: 0%, 1%, 2%, . . . , 38%, 39%, and 40%. The hydrogenated dicyclopentadiene in the HM-PSA can also be within a range defined by any two numbers listed herein, including the endpoints of such range.

In one embodiment, in the HM-PSA, the tackifying compound is hydrogenated dicyclopentadiene, which is in the range of 0 to 20% by weight of the hot-melt, pressure-sensitive adhesive. Stated differently, the tackifying hydrogenated dicyclopentadiene is any one of the numbers from the following list of numbers in percent weight of the HM-PSA: 0%, 1%, 2%, . . . , 18%, 19%, and 20%. The t hydrogenated dicyclopentadiene in the HM-PSA can also be within a range defined by any two numbers listed herein, including the endpoints of such range.

In one embodiment, in the HM-PSA, the tackifying compound is hydrogenated dicyclopentadiene, which is in the range of 0 to 10% by weight of the hot-melt, pressure-sensitive adhesive. Stated differently, the tackifying hydrogenated dicyclopentadiene is any one of the numbers from the following list of numbers in percent weight of the HM-PSA: 0%, 1%, 2%, 3%, 4%, 5%, 6%, 7%, 8%, 9%, and 10%. The hydrogenated dicyclopentadiene in the HM-PSA can also be within a range defined by any two numbers listed herein, including the endpoints of such range.

In one embodiment, the softening point of the tackifying hydrogenated dicyclopentadiene in the HM-PSA composition is equal to or more than the number listed herein, in ° C.: 110, 111, 112, . . . 148, 149, and 150. The softening point can also be a number that is within the range defined by any two numbers herein, including the endpoints of such range.

In one embodiment, the softening point of the tackifying hydrogenated dicyclopentadiene in the HM-PSA composition is equal to or more than the number listed herein, in ° C.: 115, 116, 117, . . . 138, 139, and 140. The softening point can also be a number that is within the range defined by any two numbers herein, including the endpoints of such range.

In one embodiment, the softening point of the tackifying hydrogenated dicyclopentadiene in the HM-PSA composition is equal to or more than the number listed herein, in ° C.: 120, 121, 122, 123, 124, 125, 126, 127, 128, 129, and 130. The softening point can also be a number that is within the range defined by any two numbers herein, including the endpoints of such range.

In one embodiment of the HM-PSA, more than one tackifying hydrogenated dicyclopentadiene can be used.

### C. Plasticizers

As stated supra, apart from the elastomeric block copolymers, the hot-melt, pressure-sensitive adhesive (HM-PSA) composition also includes at least one plasticizer. The plasticizer provides fluidity; modulates viscosity, peel values, and storage moduli (G′); and can generally lower the glass transition temperatures of the HM-PSA.

The plasticizer includes one or more oils. Suitable plasticizers include, for example, those that are low in volatility, transparent, and have as little color and odor as possible. Useful oils include mineral and petroleum-based hydrocarbon oils. In certain embodiments, the oils used are primarily hydrocarbon oils that are generally low in aromatic content.

In certain embodiments, the oils include hydrocarbon oils having the aromatic content in the 0-30% range, by weight. Said another way, the aromatic content of the hydrocarbon oils in any one number selected from the following list of numbers in weight percent: 0%, 1%, 2%, . . . , 28%, 29%, and 30%. The aromatic content of the hydrocarbon oils can also be within a range defined by any two numbers listed herein, including the endpoints of such range.

In certain embodiments, the oils include hydrocarbon oils having the aromatic content in the 0-15% range, by weight. Said another way, the aromatic content of the hydrocarbon oils in any one number selected from the following list of numbers in weight percent: 0%, 1%, 2%, 3%, 4%, 5%, 6%, 7%, 8%, 9%, 10%, 11%, 12%, 13%, 14%, and 15%. The aromatic content of the hydrocarbon oils can also be within a range defined by any two numbers listed herein, including the endpoints of such range.

In certain embodiments, the oils include hydrocarbon oils having paraffinic and/or naphthenic character. In certain embodiments, the oils have formula weights ranging from about 150-600 g/mole. Useful oils also include vegetable oils and their derivatives, as well as similar plasticizing liquid elastomers (e.g., polybutene). Examples of useful plasticizer oils include, but are not limited to naphthenic petroleum-based oils having 5% to 15% aromatic carbon content. In certain embodiments, suitable plasticizing oils have a Tg that ranges from −80° C. to −60° C.

In certain embodiments, one or more plasticizers may be present in the hot-melt, pressure-sensitive adhesive (HM-PSA) of the present disclosure in an amount of 10% to about 30% by weight of the HM-PSA. Stated differently, the plasticizer content in the HM-PSA is any one of the numbers from the following list of numbers in weight percent: 10%, 11%, 12%, . . . , 28%, 29%, and 30%. The plasticizer content in the HM-PSA can also be within a range defined by any two numbers listed herein, including the endpoints of such range.

In certain embodiments, one or more plasticizers may be present in the hot-melt, pressure-sensitive adhesive (HM-PSA) of the present disclosure in an amount of 20% to about 25% by weight of the HM-PSA. Stated differently, the plasticizer content in the HM-PSA is any one of the numbers from the following list of numbers in weight percent: 20%, 21%, 22%, 23%, 24%, and 25%. The plasticizer content in the HM-PSA can also be within a range defined by any two numbers listed herein, including the endpoints of such range.

### D. Optional Additives

The hot-melt, pressure-sensitive adhesive (HM-PSA) of the present invention may include one or more optional additives. Such additives, if used, may be used in amounts well-known to those skilled in the art. Examples of optional additives include pigments, fillers, antioxidants, UV-absorber and combinations thereof.

Pigments and fillers can be used to modify cohesive strength and stiffness, cold flow, and tack, as well as chemical resistance and gas permeability of a HM-PSA described herein. Inorganic fillers include both micron and nanometer particle size distributions of calcium carbonate, carbon black, clays, hydrated silicas, calcium silicates and silico-aluminates, mica, graphite, and talc. Other fillers can include glass or polymeric beads or bubbles, metal particles, fibers, and the like. Each of these additives is used in an amount sufficient to produce the desired result.

Typically, the optional additives are used in a HM-PSA described herein in an amount of from about 0.1 to 5% by weight based on the total weight of the HM-PSA. Stated another way, the optional additives are in a number from the set of numbers in the following list, as weight percent of the HM-PSA: 0.1, 0.2, 0.3, . . . , 4.8, 4.9. 5.0. The optional additives can also be within a range defined by any two numbers listed herein, including the endpoints of such range.

Typically, the optional additives are used in a HM-PSA described herein in an amount of from about 0.5 to 5% by weight based on the total weight of the HM-PSA. Stated another way, the optional additives are in a number from the set of numbers in the following list, as weight percent of the HM-PSA: 0.5%, 0.6%, 0.7%, . . . , 4.8, 4.9. 5.0. The optional additives can also be within a range defined by any two numbers listed herein, including the endpoints of such range.

Suitable antioxidants (AO) include both primary and secondary types. Primary AOs are used to provide thermal stability during solvent or melt processing of an adhesive. Secondary AOs act in tandem with the primary AO during processing and serve to increase shelf life of the coated hot-melt, pressure-sensitive adhesive. Examples include hindered phenols such as those available under the trade names IRGANOX 1076 and IRGANOX 1010 from BASF Corp. (Ludwigshafen, GE), thioesters such as that available under the trade name ARENOX DL from Reagens USA (Bayport, Tex.), phosphites such as that available under the trade name IRGAFOS 168 from BASF, and bi-functional AOs such as those available under the trade names IRGANOX 1726 and IRGANOX 1520 (both available from BASF). The AO's can be blended during the processing of the coatable adhesive compositions.

### III. Air-Barrier Membranes

In one embodiment, the hot-melt, pressure-sensitive adhesive (HM-PSA) is applied onto a carrier to form an air-barrier membrane.

### A. Discontinuous Application

In one embodiment, the hot-melt, pressure-sensitive adhesive (HM-PSA) is applied in a discontinuous fashion onto a carrier to form an air-barrier membrane, that is permeable.

In one embodiment, the air-barrier membrane of the present invention has a permeability of 5 perms or more. The metric perm is defined as 1 gram of water vapor per day, per square meter, per millimeter of mercury.

In one embodiment, the air-barrier membrane of the present invention can be applied to a substrate in a primer-less fashion. The carrier materials onto which the HM-PSA can be applied includes polyolefins, for example, polypropylene and spunbonded polypropylene; and polyester for example, melt-blown polyester. The air-barrier membrane of the present invention includes air-barriers, flashings, and tapes.

In one embodiment, the hot-melt, pressure-sensitive adhesive (HM-PSA) of the present invention provides for the making any type of air-barriers, flashings, and tapes applied in a discontinuous manner constructing permeable materials with wide application temperature range from −25° C. to 75° C. to form strong bond to itself and to the substrate, but without the use of a primer. The air-barrier membrane is applied to the substrate in a primer-less fashion, which is an advantage of the air-barrier membrane of the present invention. Stated another way, the application temperature of the air-barrier membrane, that is, the carrier on which the HM-PSA is applied is any number selected from the list of the following numbers in ° C.: −25, −24, −23, . . . , 73, 74, and 75. The application temperature of the air-barrier membrane can also be a number that is within the range defined by any two numbers herein, including the endpoints of such range.

In one embodiment, the application temperature ranges from −20° C. to 70° C. to form strong bond to itself and to the substrate, but without the use of a primer. The air-barrier membrane is applied to the substrate in a primer-less fashion, which is an advantage of the air-barrier membrane of the present invention. Stated another way, the application temperature of the air-barrier membrane, that is, the carrier on which the HM-PSA is applied is any number selected from the list of the following numbers in ° C.: −20, −19, −18, . . . , 68, 69, and 70. The application temperature of the air-barrier membrane can also be a number that is within the range defined by any two numbers herein, including the endpoints of such range.

In one embodiment, the application temperature ranges from −15° C. to 65° C. to form strong bond to itself and to the substrate, but without the use of a primer. The air-barrier membrane is applied to the substrate in a primer-less fashion, which is an advantage of the air-barrier membrane of the present invention. Stated another way, the application temperature of the air-barrier membrane, that is, the carrier on which the HM-PSA is applied is any number selected from the list of the following numbers in ° C.: −15, −14, −13, . . . , 63, 64, and 65. The application temperature of the air-barrier membrane can also be a number that is within the range defined by any two numbers herein, including the endpoints of such range.

In one embodiment, the peel-adhesion strength of the hot-melt, pressure-sensitive adhesive HM-PSA to itself and to a substrate is at least 1 lbf/in in the entire range of temperature, from about −25° C. to about 80° C.

In one embodiment, the peel-adhesion strength of the HM-PSA is greater than or equal to 4 lbf/in in the temperature range of −25° C. to +25° C., and 1 lbf/in or higher at 80° C.

### B. Continuous Application

In one embodiment, the hot-melt, pressure-sensitive adhesive (HM-PSA) is applied onto a carrier to form an air-barrier membrane.

In one embodiment, the hot-melt, pressure-sensitive adhesive (HM-PSA) is applied in a continuous fashion onto a carrier to form an air-barrier membrane, that is impermeable.

In one embodiment, the air-barrier membrane of the present invention has a permeability of 0.1 perms or less. The metric perm is defined as 1 gram of water vapor per day, per square meter, per millimeter of mercury.

In one embodiment, the air-barrier membrane of the present invention can be applied to a substrate in a primer-less fashion. The carrier materials onto which the HM-PSA can be applied includes polyolefins, for example, polypropylene and spunbonded polypropylene; and polyester for example, melt-blown polyester. The air-barrier membrane of the present invention includes air-barriers, flashings, and tapes.

In one embodiment, the hot-melt, pressure-sensitive adhesive (HM-PSA) of the present invention provides for the making any type of air-barriers, flashings, and tapes applied in a continuous manner constructing impermeable materials with wide application temperature range from −25° C. to 75° C. to form strong bond to itself and to the substrate, but without the use of a primer. The air-barrier membrane is applied to the substrate in a primer-less fashion, which is an advantage of the air-barrier membrane of the present invention. Stated another way, the application temperature of the air-barrier membrane, that is, the carrier on which the HM-PSA is applied is any number selected from the list of the following numbers in ° C.: −25, −24, −23, . . . , 73, 74, and 75. The application temperature of the air-barrier membrane can also be a number that is within the range defined by any two numbers herein, including the endpoints of such range.

In one embodiment, the application temperature ranges from −20° C. to 70° C. to form strong bond to itself and to the substrate, but without the use of a primer. The air-barrier membrane is applied to the substrate in a primer-less fashion, which is an advantage of the air-barrier membrane of the present invention. Stated another way, the application temperature of the air-barrier membrane, that is, the carrier on which the HM-PSA is applied is any number selected from the list of the following numbers in ° C.: −20, −19, −18, . . . , 68, 69, and 70. The application temperature of the air-barrier membrane can also be a number that is within the range defined by any two numbers herein, including the endpoints of such range.

In one embodiment, the application temperature ranges from −15° C. to 65° C. to form strong bond to itself and to the substrate, but without the use of a primer. The air-barrier membrane is applied to the substrate in a primer-less fashion, which is an advantage of the air-barrier membrane of the present invention. Stated another way, the application temperature of the air-barrier membrane, that is, the carrier on which the HM-PSA is applied is any number selected from the list of the following numbers in ° C.: −15, −14, −13, . . . , 63, 64, and 65. The application temperature of the air-barrier membrane can also be a number that is within the range defined by any two numbers herein, including the endpoints of such range.

In one embodiment, the peel-adhesion strength of the hot-melt, pressure-sensitive adhesive HM-PSA to itself and to a substrate is at least 1 lbf/in in the entire range of temperature, from about −25° C. to about 80° C.

In one embodiment, the peel-adhesion strength of the HM-PSA is greater than or equal to 4 lbf/in in the temperature range of −25° C. to +25° C., and 1 lbf/in or higher at 80° C.

### IV. Air-Barrier Membranes Applied to Substrates

### A. Discontinuous Application

The air-barrier membranes of the present invention can be applied onto a substrate in a primer-less fashion.

In one embodiment, the permeable air-barrier membranes of the present invention—wherein the hot-melt, pressure-sensitive adhesive (HM-PSA) is applied in a discontinuous fashion—can be applied onto a substrate in a primer-less fashion.

The substrates include gypsum board; plywood; laminated veneer lumber (LVL), particle board, fiberboard, wafer board, glue-lam beams, structural composite lumber, oriented strand board (OSB), oriented strand lumber (OSL) or parallel strand lumber (PSL), concrete masonry unit (CMU), concrete, and masonry.

### B. Continuous Application

In another embodiment, the impermeable air-barrier membranes of the present invention—wherein the hot-melt, pressure-sensitive adhesive (HM-PSA) is applied in a continuous fashion—can be applied onto a substrate in a primer-less fashion.

The substrates include gypsum board, plywood, laminated veneer lumber (LVL), particle board, fiberboard, wafer board, glue-lam beams, structural composite lumber, oriented strand board (OSB), oriented strand lumber (OSL) or parallel strand lumber (PSL), concrete masonry unit (CMU), concrete, and masonry.

### EXPERIMENTAL

Raw materials listed below in Table 1 were used to prepare the various compositions described in Tables 2 and 3.

TABLE 1
List of Ingredients for Preparation of Invention Compositions

| | Commercial | Name of | |
|---|---|---|---|
| No. | Name | Company | Name of Component |
| 1. | Nyflex ® 223 | NYNAS | Hydro-treated naphthenic oil; |
| | | AB | melting point <−20° C. |
| 2. | Kraton ® D | KRATON | Styrene-isoprene-styrene: SIS |
| | 1111 | CORP. | linear tri-block ; PS content |
| | | | 20-24% |
| 3. | Kraton ® D | KRATON | Styrene-isoprene-styrene: SIS |
| | 1161 | CORP. | linear tri-block ; PS content |
| | | | 15% |
| 4. | Solprene ® | DYNASOL, | Styrene-butadiene: SB linear, |
| | 4318 | INC. | polystyrene (PS) content 32%; |
| | | | di-block - 80% |
| 5. | Solprene ® | DYNASOL, | Styrene-butadiene: SB linear |
| | 1205 | INC. | random; styrene - 25; 17.5% as |
| | | | a PS block |
| 6. | Solprene ® | DYNASOL, | Styrene-butadiene-styrene: SBS |
| | 4302 | INC. | linear tri-block; 31% styrene; |
| | | | di-block content 20%; |
| | | | T_{g} = −89° C. |
| 7. | WestRez ® | INGEVITY | Rosin glycerol ester: SP = |
| | 5090 | CORP. | 88° C. |
| 8. | WestRez ® | INGEVITY | Rosin pentaerythritol ester: SP = |
| | 5101 | CORP. | 100 C. |
| 9. | SUKOREZ ® | KOLON | Hydrogenated dicyclopentadiene |
| | SU-230 | INDUS- | (HHR DCPD): SP = 126-135° C. |
| | | TRIES, | |
| | | INC. | |
| 10. | Teckros ® | TECKREZ, | Rosin phenolics: SP = 125° C., |
| | RP125 | INC. | T_{g} = 67° C. |
| 11. | Teckros ® | TECKREZ, | Rosin phenolics: SP = 103° C., |
| | RP103 | INC. | T_{g} = 50° C. |
| 12. | Irganox ® | BASF | Sterically hindered phenolic |
| | 1010 | | primary antioxidant |
| 13. | Irganox ® | BASF | Hindered phenolic primary |
| | 1076 | | antioxidant |
| 14. | Tinuvin ® | BASF | UV absorber |
| | 328 | | |

An adhesive composition of the present invention may be produced using techniques known in the art. The procedure involves placing all of the raw material components into a jacketed, sigma blade-type mixer, for high-viscosity mixing. A total of 400 g composition, each, was made with mixing carried out at about 175 to 190° C. The adhesive compositions were agitated until all ingredients were completely melted and mixed thoroughly to a good homogeneity.

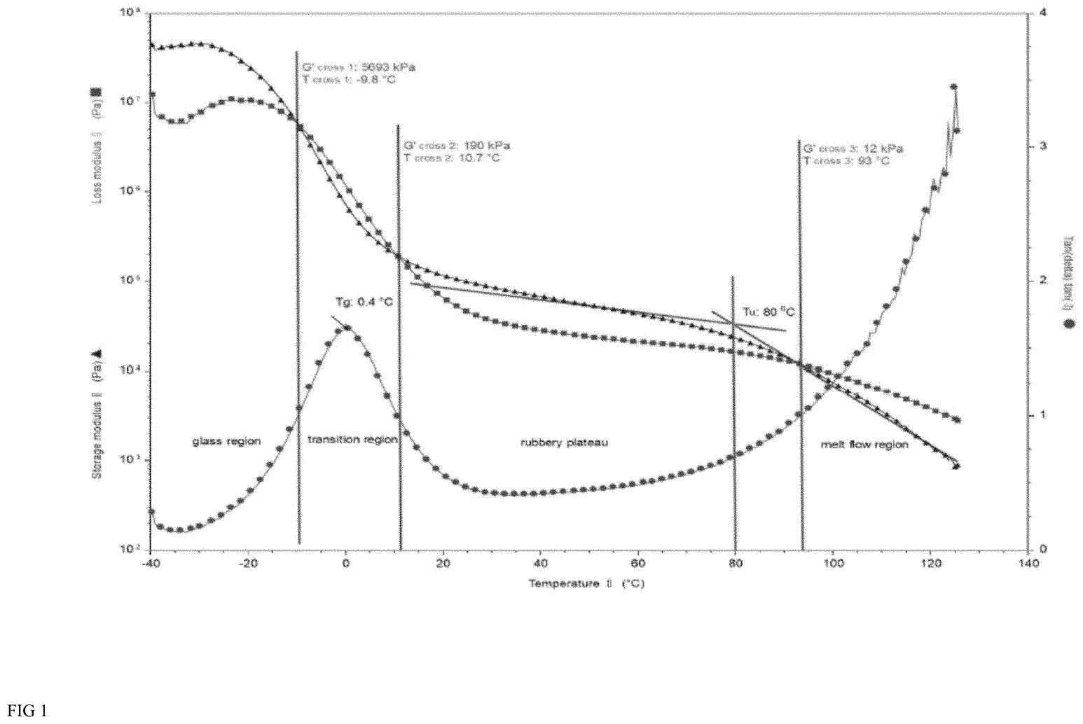

Performance of each adhesive was assessed by dynamic mechanical analysis (DMA) with a temperature sweep in a frequency response by using TA Instruments' Dynamic Mechanical Analyzer (See FIG. 1). Specifically, the loss modulus G″, and storage modulus G′ were measured. Also, the glass transition temperature T_{g} and the high temperature cross point Tₓ, that is, the third cross point of G′ and G″ after the rubbery plateau for each sample, were reported.

Performance of the adhesives was also evaluated by performing peel-adhesion strength tests. Laminated specimens were formed by using the hot-melt laboratory coater. Adhesives were applied on a polyolefin film at about 5 to 6 mils (1 mil=111000^{th} inch=25 μm) coating thicknesses, and the laminated sheets were placed on the release paper. The adhesive compositions were evaluated by conducting the peel-adhesion test: (i) to a polypropylene, spun-bond, non-woven material—Henry® Blueskin® VP160; and (ii) to a gypsum sheathing—DensGlass® Gold. The experiments were conducted at four different temperatures: −18° C.; −7° C.; 24° C.; and 80° C., following the procedure of ASTM D 903.

The invention is further illustrated by the specific examples below.

### Example 1

Table 2 illustrates 11 different compositions containing different number of ingredients in the different ratios with values of T_{g}, Tₓ, G′, and G″ in specific conditions. The results show changes in rheological behavior of the single polymers blended with oil: (i) after the introduction of the tackifying additives separately; (ii) after the introduction of the tackifying additives together; and (iii) after the introduction of the tackifying additives to the blend of two polymers. The compositions were made to get the information for further formulating the present invention.

Results clearly show that SB polymer demonstrates lower Tg and Tₓ, but higher G′ at −18, −7, and 24° C. in comparison to the SIS polymer—see, for example, See Experiments 1 and 7.

It is also evident that the rubbery plateau region of the SB polymer can be desirably extended at the high temperature end by increasing the polymer content, as shown in Experiment 8.

It is also clear that adding the tackifying agents influences the composition's viscoelastic profile significantly. Indeed, the changes in the viscoelastic profile changes will be more significant with an increase in the resin content, an increase in the rosin content, or an increase in the combined content of the resin and the rosin—see Experiments 2-6, and 9-11.

It is also seen that the hydrogenated DCPD resin affects the low temperature region profile more. On the other hand, compared to the DCPD resin, the ester rosin component impacts the high temperature region. See Experiments 2 versus 4, and 3 versus 5.

### Example 2

Table 3 illustrates the control adhesive and 15 different compositions containing 5 different polymers and 5 different tackifying agents with values of T_{g}, Tₓ, G′ and G″ in specific conditions.

Based on the dynamic thermal mechanical data, the performance of the compositions was were evaluated for their peel-adhesion to the polypropylene, spun-bond, non-woven material-Henry® Blueskin® VP 160—as a second criterion for formulating the requirements described by the present invention.

### Example 3

Table 4 illustrates the performance of the compositions in peel-adhesion to the polypropylene, spun-bond, non-woven material—Henry® Blueskin® VP 160—at four different temperatures −18, −7, 24, and 80° C.

It was found that the magnitude of adhesion to the low surface energy substrate, that is, the non-woven material, critically depends on the type of the polymer, its structure, its styrene and di-block contents, as shown in compositions 1-5 in Table 2. The difference between them is the block copolymer used.

It was also found that (even with their) relatively close rheological characteristics, the compositions provide different performance especially at room and high temperatures.

It was also found that the rosin pentaerythritol ester provides less tack compare to rosin glycerol ester, even with similar adhesion performance. See Experiments 1 and 6.

Phenolic rosin with similar softening point to rosin pentaerythritol ester, however, brought to the composition a higher tack, higher G′ value, and higher adhesion at lower temperature as well as at room temperatures. See Experiments 6 and 7.

On the other hand, a decreased adhesion was observed when the ester rosin content was increased. See Experiments 6 and 8.

Finally, introducing the hydrogenated DCPD resin or phenolic rosin to the certain ratio to the rosin ester improves peel adhesion strength. See Experiments 9 and 15.

From the above results, compositions 1, 6-10, and 14-15 were selected for further evaluation for peel-adhesion strength to the gypsum sheathing, DensGlass® Gold.

### Example 4

Table 5 illustrates the performance of the compositions for their peel-adhesion to the gypsum sheathing, DensGlass® Gold, at four different temperatures −18, −7, 24, and 80° C.

TABLE 2
Experimental HM-PSA Compositions
Compositions 1-11

| | 1 | 2 | 3 | 4 | 5 | 6 | 7 | 8 | 9 | 10 | 11 |
|---|---|---|---|---|---|---|---|---|---|---|---|
| Ingredient (g) | | | | | | | | | | | |
| Nyflex 223 | 56 | 56 | 56 | 56 | 56 | 56 | 56 | 56 | 56 | 56 | 56 |
| Kraton D 1111 | 52 | 52 | 52 | 52 | 52 | 52 | 0 | 0 | 52 | 52 | 52 |
| Snkorez SU-230 | 0 | 46 | 92 | 0 | 0 | 46 | 0 | 0 | 46 | 0 | 46 |
| WestRez 5090 | 0 | 0 | 0 | 46 | 92 | 92 | 0 | 0 | 0 | 92 | 92 |
| Solprene 1205 | 0 | 0 | 0 | 0 | 0 | 0 | 52 | 80 | 80 | 80 | 80 |
| DMA Readings | | | | | | | | | | | |
| Tg, ° C. | −48 | −16 | 13 | −21 | −4 | 16 | −57 | −61 | −35 | −26 | −12 |
| High T cross | 161 | 109 | 109 | 96 | 75 | 75 | 125 | 141 | 115 | 94 | 77 |
| point, ° C. | | | | | | | | | | | |
| G′ at −18 C., | 59 | 480 | 44887 | 288 | 14821 | | 124 | 173 | 241 | 399 | 3530 |
| KPa | | | | | | | | | | | |
| G′ at −7 C. KPa | 44 | 69 | 19504 | 71 | 513 | 36224 | 94 | 132 | 152 | 180 | 152 |
| G′ at 24 C. KPa | 21 | 14 | 35 | 25 | 21 | 23 | 36 | 56 | 59 | 60 | 64 |
| G′ at 80 C. KPa | 18 | 5 | 11 | 25 | 4 | 0.8 | 9 | 14 | 23 | 13 | 8 |

TABLE 3
Experimental Compositions with Tackifying Agents

| | | Weight parts | | | | | | | | | | | | | | |
|---|---|---|---|---|---|---|---|---|---|---|---|---|---|---|---|---|
| | Ctrl | 1 | 2 | 3 | 4 | 5 | 6 | 7 | 8 | 9 | 10 | 11 | 12 | 13 | 14 | 15 |
| Ingredient | | | | | | | | | | | | | | | | |
| Irganox 1010 | | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Irganox 1076 | | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Tinuvin 328 | | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Nyflex 223 | | 20 | 20 | 20 | 20 | 20 | 20 | 20 | 20 | 20 | 24 | 24 | 24 | 24 | 22 | 22 |
| Kraton D | | 23.5 | 0 | 23.5 | 23.5 | 23.5 | 23.5 | 23.5 | 22 | 23 | 23 | 23 | 23 | 23 | 22 | 22 |
| 1111 | | | | | | | | | | | | | | | | |
| Kraton D | | 0 | 23.5 | 0 | 0 | 0 | 0 | 0 | 0 | 0 | 0 | 0 | 0 | 0 | 0 | 0 |
| 1161 | | | | | | | | | | | | | | | | |
| Solprene | | 23.5 | 23.5 | 0 | 0 | 11.25 | 23.5 | 23.5 | 22 | 23 | 23 | 23 | 23 | 23 | 22 | 22 |
| 1205 | | | | | | | | | | | | | | | | |
| Solprene | | 0 | 0 | 23.5 | 0 | 0 | 0 | 0 | 0 | 0 | 0 | 0 | 0 | 0 | 0 | 0 |
| 4318 | | | | | | | | | | | | | | | | |
| Solprene | | 0 | 0 | 0 | 23.5 | 11.25 | 0 | 0 | 0 | 0 | 0 | 0 | 0 | 0 | 0 | 0 |
| 4302 | | | | | | | | | | | | | | | | |
| WestRez | | 33 | 33 | 33 | 33 | 33 | 0 | 0 | 0 | 0 | 0 | 0 | 0 | 0 | 0 | 0 |
| 5090 | | | | | | | | | | | | | | | | |
| WestRez | | 0 | 0 | 0 | 0 | 0 | 33 | 0 | 36 | 14 | 10 | 0 | 20 | 20 | 24 | 24 |
| 5101 | | | | | | | | | | | | | | | | |
| Teckroz | | 0 | 0 | 0 | 0 | 0 | 0 | 33 | 0 | 0 | 0 | 10 | 0 | 0 | 0 | 0 |
| RP103 | | | | | | | | | | | | | | | | |
| Teckroz | | 0 | 0 | 0 | 0 | 0 | 0 | 0 | 0 | 0 | 0 | 0 | 0 | 10 | 0 | 10 |
| RP125 | | | | | | | | | | | | | | | | |
| Sukorez | | 0 | 0 | 0 | 0 | 0 | 0 | 0 | 0 | 20 | 20 | 20 | 10 | 0 | 10 | 0 |
| SU-230 | | | | | | | | | | | | | | | | |
| DMA Reading | | | | | | | | | | | | | | | | |
| Tg, ° C. | −0.5 | −24 | −25 | −23 | −21 | −12 | −21 | −20 | −17 | −17 | −24 | −21 | −25 | −21 | −20 | −16 |
| High T | 97 | 97 | 78 | 107 | 95 | 108 | 99 | 99 | 99 | 107 | 107 | 107 | 105 | 101.5 | 102 | 99 |
| cross point, | | | | | | | | | | | | | | | | |
| ° C. | | | | | | | | | | | | | | | | |
| G′ at −18° C., | 19179 | 534 | 424 | 1029 | 1191 | 3612 | 549 | 1238 | 1033 | 1279 | 375 | 580 | 339 | 709 | 710 | 1293 |
| KPa | | | | | | | | | | | | | | | | |
| G′ at −7° C., | 2652 | 226 | 185 | 405 | 406 | 342 | 191 | 380 | 240 | 280 | 152 | 191 | 151 | 242 | 202 | 292 |
| KPa | | | | | | | | | | | | | | | | |
| G′ at 24° C., | 92 | 82 | 71 | 124 | 125 | 60 | 67 | 102 | 76 | 83 | 62 | 63 | 62 | 76 | 63 | 64 |
| KPa | | | | | | | | | | | | | | | | |
| G′ at 80° C., | 24 | 22 | 12 | 38 | 48 | 15 | 17 | 29 | 23 | 26 | 21 | 19 | 21 | 20.5 | 17 | 16 |
| KPa | | | | | | | | | | | | | | | | |

TABLE 4
Adhesion to the Non-Woven Polypropylene Fabric (Blueskin ® VP160), lbf/in

| Temp. | | | | | | | | | | | | | | | | |
|---|---|---|---|---|---|---|---|---|---|---|---|---|---|---|---|---|
| ° C. | Ctrl | 1 | 2 | 3 | 4 | 5 | 6 | 7 | 8 | 9 | 10 | 11 | 12 | 13 | 14 | 15 |
| −18 | 0.6 | 4.1 | 4.9 | 3.5 | | | 5.1 | 7.4 | 5.8 | 9.7 | 6.3 | 5.0 | 5.3 | 8.2 | 9.5 | 8.2 |
| −7 | 3.9 | 8.6 | 7.7 | 6.9 | | | 9.2 | 7.3 | 5.4 | 9.0 | 6.9 | 5.5 | 5.5 | 7.9 | 8.6 | 8.5 |
| 24 | 4.4 | 3.6 | 3.5 | 1.0 | 0.6 | 1.6 | 3.3 | 4.6 | 2.8 | 4.9 | 2.6 | 1.8 | 1.5 | 4.0 | 4.2 | 5.7 |
| 80 | 0.9 | 1.4 | 0.5 | 1.1 | 1.2 | 1.6 | 1.7 | 1.3 | 1.2 | 1.5 | 0.8 | 0.4 | 0.4 | 1.1 | 1.1 | 1.6 |

TABLE 5
Adhesion to the Gypsum Sheathing (DensGlass Gold), lbf/in

| Temp. | | | | | | | | | | |
|---|---|---|---|---|---|---|---|---|---|---|
| ° C. | Ctrl | 1 | 6 | 7 | 8 | 9 | 10 | 13 | 14 | 15 |
| −18 | 0.8 | 4.4 | 5.0 | 3.2 | 4.0 | 7.0 | 7.3 | 5.9 | 6.2 | 10.1 |
| −7 | 1.7 | 4.8 | 6.0 | 3.2 | 3.6 | 7.1 | 7.5 | 6.0 | 7.1 | 10.5 |
| 24 | 5.9 | 2.5 | 2.7 | 3.5 | 1.6 | 4.7 | 4.2 | 4.5 | 6.7 | 8.3 |
| 80 | 0.9 | 1.3 | 1.5 | 1.8 | 1.1 | 1.3 | 1.4 | 1.2 | 1.5 | 1.5 |

1. A hot-melt, pressure-sensitive adhesive (HM-PSA) composition, comprising a blend of the following components:
(A) at least one elastomeric copolymer selected from a styrene-isoprene elastomeric block copolymer (SIS); a styrene-butadiene elastomeric copolymer (SB); and a combination of SIS and SB;
(B) at least one tackifying compound selected from:
(I) at least one tackifying rosin ester having a softening point (SP) equal to or above the temperature selected from the range of from about 95° C. to about 125° C.,
(II) at least one tackifying rosin phenolics having a softening point equal to or above the temperature selected from the range of from about 95° C. to about 125° C., and
(III) at least one hydrogenated dicyclopentadiene resin having a softening point (SP) of at least about 125° C.; and
(C) a plasticizer;
wherein the glass transition temperature of the HM-PSA composition is equal to or below the temperature in the range of from about 0° C. to about −30° C.;
wherein the storage modulus (G′) at −18° C. is in the range of from about 300-2000 KPa; and
wherein the high T cross point of the HM-PSA composition is equal to or above the temperature in the range of from about 95° C. to about 125° C.

2. The HM-PSA composition as recited in claim 1, wherein said SB copolymer is selected from:
(i) a copolymer of SB;
(ii) a block copolymer of SB;
(iii) a radial, block copolymer of SB;
(iv) a linear, block copolymer of SB;
(v) a linear, random-block copolymer of SB; and
(vi) a blend or a combination of the above.

3. The HM-PSA composition as recited in claim 1, wherein the total content of said at least one elastomeric block copolymer, by percent weight of the HM-PSA composition is in the range of from about 20% to about 50%.

4. The HM-PSA composition as recited in claim 3, wherein:
(A) the SIS copolymer is a tri-block copolymer and is in the weight range of from 8% to about 30% by weight of the HM-PSA composition; and
(B) the SB copolymer is in the weight range of from about 8% to about 30% by weight of the HM-PSA composition.

5. The HM-PSA composition as recited in claim 4, wherein:
(C) said at least one tackifying rosin ester is in the weight range of from about 0% to about 40% by weight of the HM-PSA composition;
(D) said at least one tackifying rosin phenolics is in the weight range of from about 0% to about 40% by weight of the HM-PSA composition;
(E) said at least one hydrogenated dicyclopentadiene resin is in the weight range of from about 0% to about 40% by weight of the HM-PSA composition; and
(F) said plasticizer is in the weight range of from about 10% to about 30% by weight of the HM-PSA composition.

6. The hot-melt pressure-sensitive adhesive composition as recited in claim 5, wherein:
(A) the SIS copolymer is in the weight range of from 11% to about 24% by weight of the HM-PSA composition;
(B) the SB copolymer is in the weight range of from about 11% to about 24% by weight of the HM-PSA composition;
(C) the at least one tackifying rosin ester is in the weight range of from about 10% to about 36% by weight of the HM-PSA composition; and/or
(D) the at least one tackifying rosin phenolics is in the weight range of from about 0% to about 33% by weight of the HM-PSA composition;
(E) the at least one hydrogenated dicyclopentadiene resin is in the weight range of from about 0% to about 20% by weight of the HM-PSA composition; and
(F) the plasticizer is in the weight range of from about 19% to about 24% by weight of the HM-PSA composition.

7. The hot-melt pressure-sensitive adhesive composition as recited in claim 5, wherein:
(A) the SIS copolymer is in the weight range of from 21% to about 23% by weight of the HM-PSA composition;
(B) the SB copolymer is in the weight range of from about 21% to about 23% by weight of the HM-PSA composition;
(C) the at least one tackifying rosin ester is in the weight range of from about 13% to about 24% by weight of the HM-PSA composition;
(D) the at least one tackifying rosin phenolics is in the weight range of from about 0% to about 10% by weight of the HM-PSA composition; and
(E) the at least one hydrogenated dicyclopentadiene resin is in the weight range of from about 0% to about 20% by weight of the HM-PSA composition.

8. The HM-PSA composition as recited in claim 1, wherein the at least one tackifying rosin phenolics are characterized a softening point of at least about 120° C.

9. The HM-PSA composition of claim 1, wherein the SIS copolymer has a styrene content of from about 10% to about 29%.

10. The HM-PSA composition of claim 1, wherein the SIS copolymer is characterized by a linear tri-block structure.

11. The HM-PSA composition of claim 1, wherein the SB copolymer has a styrene content of from about 10% to about 29%.

12. The HM-PSA composition of claim 1, wherein the SB copolymer is characterized by a linear random structure.

13. The HM-PSA composition as recited in claim 1, wherein said melt-adhesive is characterized by an application temperature range of from about −25° C. to about 70° C.

14. The HM-PSA composition as recited in claim 1, wherein said melt-adhesive is characterized by a peel-adhesion strength that is at least 1 lbf/in (175 N/m) the temperature range of −25° C. to 80° C.

15. The HM-PSA composition as recited in claim 1, wherein said melt-adhesive is characterized by a peel-adhesion strength that is at least 4 lbf/in (700 N/m) in the temperature range of −25° C. to 25° C., and at least 1 lbf/in (175 N/m) at 80° C.

16. A method for preparing an air-barrier membrane, comprising:
(a) providing a HM-PSA composition in a form adequate for application on a carrier; and
(b) applying said HM-PSA composition on said carrier in a discontinuous pattern, to form said air-barrier membrane;
wherein said HM-PSA composition comprises a blend of the following components:
(A) at least one elastomeric block copolymer selected from a styrene-isoprene elastomeric block copolymer (SIS); a styrene-butadiene elastomeric block copolymer (SB); a combination of SIS and SB;
(B) at least one tackifying compound selected from:
(I) at least one tackifying rosin ester having a softening point (SP) equal to or above the temperature selected from the range of from about 95° C. to about 125° C.;
(II) at least one tackifying rosin phenolics having a softening point equal to or above the temperature selected from the range of from about 95° C. to about 125° C.; and;
(III) at least one hydrogenated dicyclopentadiene resin having a softening point (SP) of at least about 125° C.; and
(C) a plasticizer;
wherein the glass transition temperature of the HM-PSA composition is equal to or below the temperature in the range of from about 0° C. to about −30° C.;
wherein the storage modulus (G′) at −18° C. is in the range of from about 300-2000 KPa; and
wherein the high T cross point of the HM-PSA composition is equal to or above the temperature in the range of from about 95° C. to about 125° C.

17. An air-barrier membrane comprising a HM-PSA composition layer as recited in claim 1, wherein said HM-PSA composition layer is applied in a discontinuous pattern.

18. The air-barrier membrane as recited in claim 17, wherein said carrier is selected from polyolefin and polyester.

19. The air-barrier membrane as recited in claim 18, wherein said polyolefin is selected from polyethylene, polypropylene, a copolymer of polyethylene, a copolymer of polypropylene, a blend thereof, or a mixture thereof.

20. A method for applying an air-barrier membrane onto a substrate, comprising:
(a) providing an air-barrier membrane as described in claim 17, that is adequate for application on a carrier; and
(b) applying said air-barrier membrane without a primer on said substrate to form a covered substrate;
wherein said HM-PSA composition comprises a blend of the following components:
(A) at least one elastomeric block copolymer selected from a styrene-isoprene elastomeric block copolymer (SIS); a styrene-butadiene elastomeric block copolymer (SB); a combination of SIS and SB;
(B) at least one tackifying compound selected from:
(I) at least one tackifying rosin ester having a softening point (SP) equal to or above the temperature selected from the range of from about 95° C. to about 125° C.;
(II) at least one tackifying rosin phenolics having a softening point equal to or above the temperature selected from the range of from about 95° C. to about 125° C.; and;
(III) at least one hydrogenated dicyclopentadiene resin having a softening point (SP) of at least about 125° C.; and
(C) a plasticizer;
wherein the glass transition temperature of the HM-PSA composition is equal to or below the temperature in the range of from about 0° C. to about −30° C.;
wherein the storage modulus (G′) at −18° C. is in the range of from about 300-2000 KPa; and
wherein the high T cross point of the HM-PSA composition is equal to or above the temperature in the range of from about 95° C. to about 125° C.

21. A covered substrate prepared by the method of claim 20.

22. The substrate as recited in claim 21, wherein said substrate is selected from gypsum board, plywood, laminated veneer lumber (LVL), particle board, fiberboard, wafer board, glue-lam beams, structural composite lumber, oriented strand board (OSB), oriented strand lumber (OSL) or parallel strand lumber (PSL), concrete masonry unit (CMU), concrete, and masonry.

23. A method for preparing an air-barrier membrane, comprising:
(a) providing a HM-PSA composition in a form adequate for application on a carrier; and
(b) applying said HM-PSA composition on said carrier in a continuous pattern, to form said air-barrier membrane;
wherein said HM-PSA composition comprises a blend of the following components:
(A) at least one elastomeric block copolymer selected from a styrene-isoprene elastomeric block copolymer (SIS); a styrene-butadiene elastomeric block copolymer (SB); a combination of SIS and SB;
(B) at least one tackifying compound selected from:
(I) at least one tackifying rosin ester having a softening point (SP) equal to or above the temperature selected from the range of from about 95° C. to about 125° C.;
(II) at least one tackifying rosin phenolics having a softening point equal to or above the temperature selected from the range of from about 95° C. to about 125° C.; and;
(III) at least one hydrogenated dicyclopentadiene resin having a softening point (SP) of at least about 125° C.; and
(C) a plasticizer;
wherein the glass transition temperature of the HM-PSA composition is equal to or below the temperature in the range of from about 0° C. to about −30° C.;
wherein the storage modulus (G′) at −18° C. is in the range of from about 300-2000 KPa; and
wherein the high T cross point of the HM-PSA composition is equal to or above the temperature in the range of from about 95° C. to about 125° C.

24. An air-barrier membrane comprising a HM-PSA composition layer as recited in claim 1, wherein said HM-PSA composition layer is applied in a continuous pattern.

25. The air-barrier membrane as recited in claim 24, wherein said carrier is selected from polyolefin and polyester.

26. The air-barrier membrane as recited in claim 25, wherein said polyolefin is selected from polyethylene, polypropylene, a copolymer of polyethylene, a copolymer of polypropylene, a blend thereof, or a mixture thereof.

27. A method for applying an air-barrier membrane onto a substrate, comprising:
(a) providing an air-barrier membrane as described in claim 24, that is adequate for application on a carrier; and
(b) applying said air-barrier membrane without a primer on said substrate to form a covered substrate;
wherein said HM-PSA composition comprises a blend of the following components:
(A) at least one elastomeric block copolymer selected from a styrene-isoprene elastomeric block copolymer (SIS); a styrene-butadiene elastomeric block copolymer (SB); a combination of SIS and SB;
(B) at least one tackifying compound selected from:
(I) at least one tackifying rosin ester having a softening point (SP) equal to or above the temperature selected from the range of from about 95° C. to about 125° C.;
(II) at least one tackifying rosin phenolics having a softening point equal to or above the temperature selected from the range of from about 95° C. to about 125° C.; and;
(III) at least one hydrogenated dicyclopentadiene resin having a softening point (SP) of at least about 125° C.; and
(C) a plasticizer;
wherein the glass transition temperature of the HM-PSA composition is equal to or below the temperature in the range of from about 0° C. to about −30° C.;
wherein the storage modulus (G′) at −18° C. is in the range of from about 300-2000 KPa; and
wherein the high T cross point of the HM-PSA composition is equal to or above the temperature in the range of from about 95° C. to about 125° C.

28. A covered substrate prepared by the method of claim 27.

29. The substrate as recited in claim 28, wherein said substrate is selected from gypsum board, plywood, laminated veneer lumber (LVL), particle board, fiberboard, wafer board, glue-lam beams, structural composite lumber, oriented strand board (OSB), oriented strand lumber (OSL) or parallel strand lumber (PSL), concrete masonry unit (CMU), concrete, and masonry.
